(19) United States
(12) Patent Application Publication
(10) Pub. No.: US 2021/0346729 A1
(43) Pub. Date: Nov. 11, 2021

(54) PERSONAL PROTECTIVE EQUIPMENT AND METHODS OF USE FOR PROVIDING AN AIR SHIELD FROM AIRBORNE PATHOGENS AND OTHER HARMFUL PARTICLES

(71) Applicant: Andrew Wagner, Elm City, NC (US)

(72) Inventor: Andrew Wagner, Elm City, NC (US)

(21) Appl. No.: 16/870,036

(22) Filed: May 8, 2020

(51) Int. Cl. A62B 18/00

(52) U.S. Cl. CPC A62B 18/003

(57) ABSTRACT

Personal protective equipment and methods for providing an air shield from airborne pathogens and other harmful particles are disclosed. According to an aspect, personal protective equipment for providing an air shield includes a body having a first end and a second end. The body defines an interior channel that extends between the first end and the second end. Further, the body defines an inlet opening extending from an exterior of the body to the interior channel for receipt of air into the interior channel. The body also defines one or more outlet openings that extend between the interior channel and the exterior of the body for exit of air from the interior channel. The personal protective equipment also includes an attachment mechanism attached to the body and being configured to affix the body to another object.

### TECHNICAL FIELD

The presently disclosed subject matter relates generally to personal protective equipment. Particularly, the presently disclosed subject matter relates to personal protective equipment and methods for providing an air shield from airborne pathogens and other harmful particles.

### BACKGROUND

Pathogens can be transmitted through the air over time and distance by small particles to deliver airborne disease to humans. In this manner, such pathogens can spread disease to a human from another human or another source. For example, they may be spread through breathing, talking, coughing, sneezing, raising of dust, spraying of liquids, toilet flushing, or any activities which generate aerosol particles or droplets.

Personal protective equipment have been developed to protect humans from airborne pathogens and other harmful airborne particles. Such equipment includes protective clothing, hats, goggles, gloves, and masks. These wearable items have routinely been used in healthcare settings, such as hospitals, laboratories and factories, but more recently the usage of personal protective equipment has extended to public places such as grocery stores, gas service stations, retail stores, restaurants, parks, and sporting events. It is noted that personal protective equipment have also been developed to protect humans from adverse health conditions caused by air pollution such as volatile organic compounds, gases, and any other potentially-harmful, airborne particles.

Recently, there is a greater interest in the use of personal protective equipment for protection against airborne pathogens or other harmful airborne particles. There is a continuing desire to provide improvements in the costs, effectiveness, and convenience of personal protective equipment.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a perspective view of personal protective equipment for providing an air shield in accordance with embodiments of the present disclosure;

FIG. 2 is a front view of the personal protective equipment shown in FIG. 1;

FIG. 3 is a top view of the personal protective equipment shown in FIGS. 1 and 2;

FIG. 4 is a diagram of an air flow system of a PPE in accordance with embodiments of the present disclosure; and

FIG. 5 is an image showing a PPE being attached to a baseball cap being worn by a mannequin head.

### SUMMARY

The presently disclosed subject matter provides personal protective equipment and methods for providing an air shield from airborne pathogens and other harmful particles. According to an aspect, personal protective equipment for providing an air shield includes a body having a first end and a second end. The body defines an interior channel that extends between the first end and the second end. Further, the body defines an inlet opening extending from an exterior of the body to the interior channel for receipt of air into the interior channel. The body also defines one or more outlet openings that extend between the interior channel and the exterior of the body for exit of air from the interior channel. The personal protective equipment also includes an attachment mechanism attached to the body and being configured to affix the body to another object.

According to another aspect, a method for providing an air shield includes providing personal protective equipment. The personal protective equipment includes a body having a first end and a second end. The body defines an interior channel that extends between the first end and the second end. Further, the body defines an inlet opening extending from an exterior of the body to the interior channel for receipt of air into the interior channel. The body also defines one or more outlet openings that extend between the interior channel and the exterior of the body. The personal protective equipment also includes an attachment mechanism attached to the body and being configured to affix the body to another object. Further, the method includes forcing air into the inlet opening such that air flow into the interior channel and out the outlet opening(s).

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

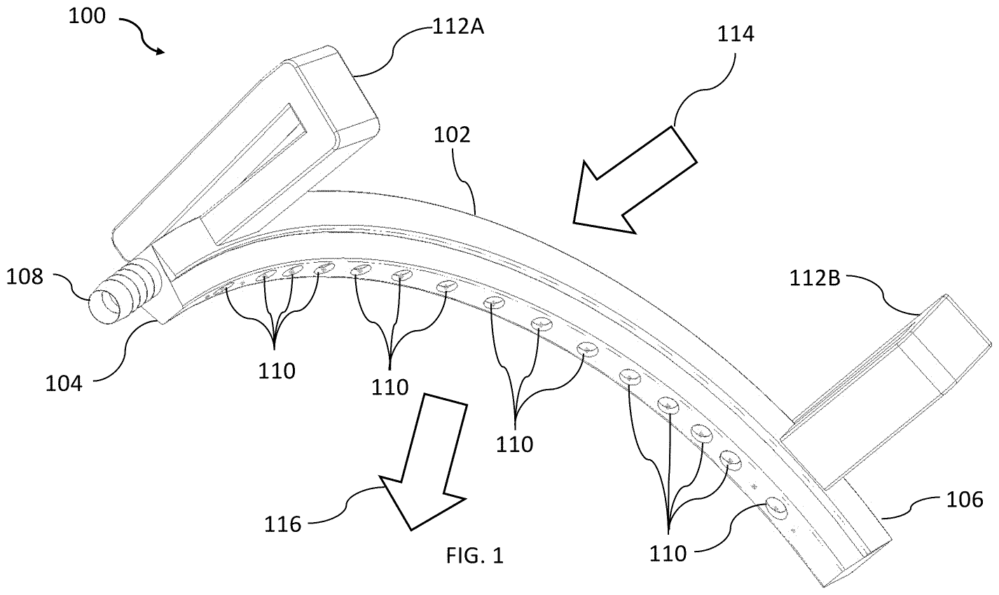

FIG. 1 illustrates a perspective view of personal protective equipment (PPE) 100 for providing an air shield in accordance with embodiments of the present disclosure. Referring to FIG. 1, the PPE 100 includes a body 102 having a first end 104 and a second end 106. The body 102 in this example is elongated in shape, and end 104 is at an end of the body 102 that opposes end 106. Further, the body 102 is substantially squared in shape. Further, in this example, the length of body 102 between ends 104 and 106 is substantially curved in shape. It should be noted that alternative to the shape of the body 102 shown in FIG. 1, the body may be otherwise suitably shaped, sized, and dimensioned.

With continuing reference to FIG. 1, the body 102 defines an inlet opening 108. The opening 108 is configured to receive air supply (not shown). For example, the opening may be formed by a nozzle as shown in this figure or any other suitable opening configured to fluidly attached to the air supply. As an example, the air supply may be an air pump configured to generate a flow of air and to direct the flow of air into the inlet opening 108. A flexible tubing (not shown) may be used to operatively connect the air supply to the inlet opening 108 for providing a passageway for the flow of air between the air supply and the inlet opening 108.

As described in further detail herein, the air pump can deliver air into the opening 108 at a sufficient pressure such that air flows through an interior channel (not shown) and out of outlet openings 110 defined by the body 102. The body 102 defines the interior channel, which extends between ends 104 and 106. More particularly, the inlet opening 108 extends from an exterior of the body 102 to the interior channel for receipt of air into the interior channel, and the outlet openings 110 extend between the interior channel and the exterior of the body 102 for exit of air from the interior channel. In the example of FIG. 1, the openings 108 and 110 are circular, but may alternatively be any other suitable shape, dimension size, and number. Further, in this example, the openings 110 are substantially aligned between ends 104 and 106. Also, in this example, the openings 110 are each spaced apart from a neighboring opening 110 by about the same distance, but they may be spaced apart from each other at any suitable distance.

With continuing reference to FIG. 1, the PPE 100 includes an attachment mechanism having clips 112A and 112B that are attached to ends 104 and 106, respectively, of the body 102. The clips 112A and 112B are configured to attach the body 102 to headgear of a person. For example, the clips 112A and 112B may attach to the bill of a baseball cap or any other suitable portion of headgear. As shown, the clips 112A and 112B are aligned in substantially the same direction, indicated generally by arrow 114, for attachment to the headgear. It is noted that the outlet openings 110 face in a direction, indicated generally by arrow 116, thus air exiting the outlet openings 110 flows in substantially the direction of arrow 116. Further, it is noted that the directions indicated by arrows 114 and 116 are substantially orthogonal such that when attached to headgear worn by a person, the air exiting openings 110 flows in front of the person's face. It is noted that the attachment mechanism may be adjustable such that the air flows in an optimized direction in front of the person's face when attached to the headgear. It is further noted that the attachment mechanism may alternatively include any suitable components for attachment to headgear.

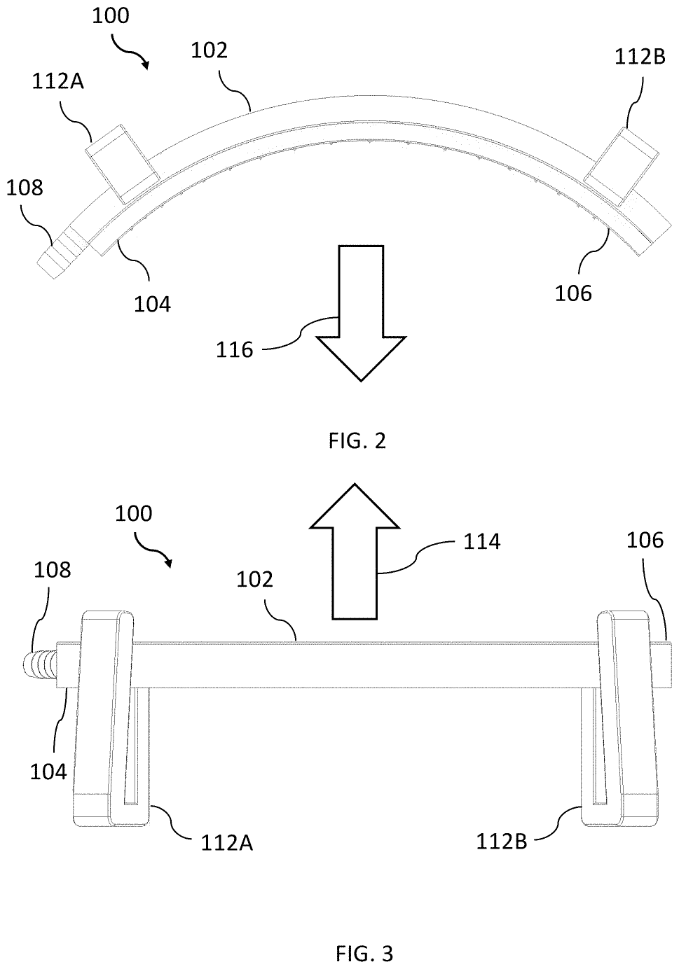

FIG. 2 illustrates a front view of the PPE 100 shown in FIG. 1. Referring to FIG. 2, the figure shows that the direction (indicated by arrow 116) of air flow out of openings 110 is generally downward.

FIG. 3 illustrates a top view of the PPE 100 shown in FIGS. 1 and 2. Referring to FIG. 3, the figure shows that the direction (indicated by arrow 114) towards attachment to headgear is generally backward.

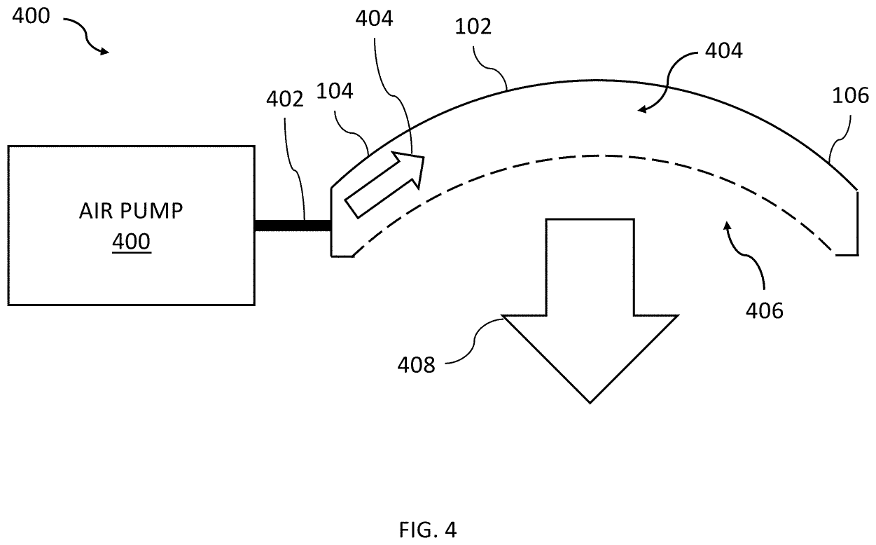

FIG. 4 illustrates a diagram of an air flow system 400 of a PPE in accordance with embodiments of the present disclosure. Referring to FIG. 4, the system 400 includes an air pump 402, a tubing 404, and the body 102. The air pump 404 can be turned on or activated to force air into an end of the tubing 404 to thereby generate an air flow towards the opposing end of the tubing 404, which is operatively connected to the body 102. Particularly, this opposing end of the tubing 404 can be operatively connected to an inlet opening (e.g., inlet opening 108 shown in FIG. 1) of the body 102. The air flow may subsequently enter an interior channel, generally designated 404, of the body 102. The air flow into the interior channel is represented by arrow 406 and can traverse through the interior channel 404 from 104 to end 106. The body 102 can be sealed except for outlet openings, generally designated 406, on a side of the body 102. These openings 406 are shown also by example as outlet openings 110 in FIG. 1. The air flow in the interior channel 404 can be forced out of the outlet openings 406 to flow in a direction generally indicated by arrow 408 to thereby form an air shield in front of a person's face.

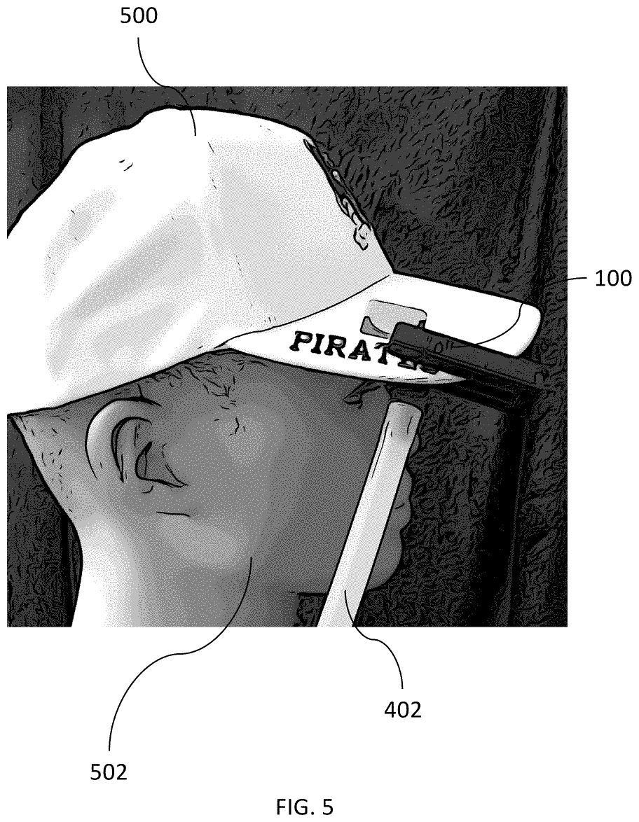

FIG. 5 is an image showing a PPE 100 being attached to a baseball cap 500 being worn by a mannequin head 502. Referring to FIG. 5, the tubing 402 attached to the body of the PPE 100 is shown. In this example, the tubing 402 is made of a flexible material.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. Personal protective equipment for providing an air shield, the apparatus comprising:
a body having a first end and a second end, the body defining an interior channel that extends between the first end and the second end, the body defining an inlet opening extending from an exterior of the body to the interior channel for receipt of air into the interior channel, and the body defining at least one outlet opening that extends between the interior channel and the exterior of the body for exit of air from the interior channel; and
an attachment mechanism attached to the body and being configured to affix the body to another object.

2. The personal protective equipment of claim 1, wherein the body is elongated in shape.

3. The personal protective equipment of claim 2, wherein the body is substantially curved in shape.

4. The personal protective equipment of claim 1, wherein the at least one outlet opening comprises a plurality of outlet openings.

5. The personal protective equipment of claim 4, wherein the outlet openings are substantially aligned between the first and second ends.

6. The personal protective equipment of claim 5, wherein the outlet openings face in substantially the same direction.

7. The personal protective equipment of claim 5, wherein the outlet openings are each spaced apart from a neighboring outlet opening by about the same distance.

8. The personal protective equipment of claim 1, wherein the body is substantially curved in shape to define a space within an interior of the curve, and
wherein the at least one outlet opening comprises a plurality of outlet openings that face towards the space within the interior of the curve.

9. The personal protective equipment of claim 1, wherein the attachment mechanism comprises a clip.

10. The personal protective equipment of claim 1, wherein the attachment mechanism comprises a first clip and a second clip attached to the first end and the second end, respectively, of the body.

11. The personal protective equipment of claim 10, wherein the clips are configured to attach the body to headgear.

12. The personal protective equipment of claim 10, wherein the clips are aligned in substantially the same direction.

13. The personal protective equipment of claim 1, wherein the attachment mechanism is configured to attach to an object in a first direction,
wherein the at least one outlet opening faces a second direction for the exit of air in substantially the second direction, and
wherein the first direction and the second direction are substantially orthogonal.

14. The personal protective equipment of claim 13, wherein the at least one outlet opening comprises a plurality of outlet openings.

15. The personal protective equipment of claim 1, further comprising an air supply being fluidly attached to the inlet opening and configured to generate a flow of air and to direct the flow of air into the inlet opening.

16. The personal protective equipment of claim 15, further comprising a flexible tubing operatively connected to the air supply and the inlet opening for providing a passageway for the flow of air between the air supply and the inlet opening.

17. The personal protective equipment of claim 16, further comprising a nozzle operatively connected to the inlet opening for operative attachment to the flexible tubing.

18. The personal protective equipment of claim 1, wherein the inlet opening is positioned at one of the first end and the second end of the body.

19. A method for providing an air shield, the method comprising:
providing personal protective equipment comprising
a body having a first end and a second end, the body defining an interior channel that extends between the first end and the second end, the body defining an inlet opening extending from an exterior of the body to the interior channel for receipt of air into the interior channel, and the body defining at least one outlet opening that extends between the interior channel and the exterior of the body; and
an attachment mechanism attached to the body and being configured to affix the body to another object; and
forcing air into the inlet opening such that air flow into the interior channel and out the at least one outlet opening.

20. The method of claim 19, wherein the at least one outlet opening comprises a plurality of outlet openings, and
wherein the method further comprising using the attachment mechanism to attach the body to headgear of a person.
